(19) United States
(12) Patent Application Publication
(10) Pub. No.: US 2018/0122560 A1
(43) Pub. Date: May 3, 2018

(54) MULTILAYER INDUCTOR AND METHOD FOR MANUFACTURING MULTILAYER INDUCTOR

(71) Applicant: FDK CORPORATION, Tokyo (JP)

(72) Inventors: Kenji OKUDA, Tokyo (JP); Daisuke Matsubayashi, Tokyo (JP); Mikio Kitaoka, Tokyo (JP); Shohei Itagaki, Tokyo (JP)

(73) Assignee: FDK CORPORATION, Tokyo (JP)

(21) Appl. No.: 15/860,218

(22) Filed: Jan. 2, 2018

Related U.S. Application Data
(63) Continuation of application No. PCT/JP2016/070236, filed on Jul. 8, 2016.

(30) Foreign Application Priority Data
Jul. 17, 2015 (JP) 2015-143026

(51) Int. Cl. H01F 27/28; H01F 27/24; H01F 41/02; H01F 41/04

(52) U.S. Cl. CPC H01F 27/2804; H01F 27/24; H01F 2027/2809; H01F 41/043; H01F 41/0206

(57) ABSTRACT

A multilayer inductor includes a stack including a coil spirally wound and overlapped in a stacking direction in a magnetic body, an electrode provided on a bottom surface of the stack, a connecting conductor that passes through the stack toward the bottom surface from one end of the coil to the electrode to connect the end of the coil with the electrode, and a nonmagnetic part that surrounds the connecting conductor.

### CROSS-REFERENCE TO RELATED APPLICATION

This application is a continuation of International Application No. PCT/JP2016/070236, filed on Jul. 8, 2016 which claims the benefit of priority of the prior Japanese Patent Application No. 2015-143026, filed on Jul. 17, 2015, the entire contents of which are incorporated herein by reference.

### FIELD

The embodiments discussed herein are related to a multilayer inductor and a method for manufacturing a multilayer inductor.

### BACKGROUND

Conventional transformers and choke coils used in power supply circuits such as DC-DC converters typically consist of a coil wound around a magnetic core. Due to the recent increase in demand for smaller and thinner components for the power supply circuits, inductors having a multilayer structure (that is, multilayer inductors) have been developed and widely used.

Such a multilayer inductor includes magnetic layers and conductor pattern layers that are deposited to form a stack. The conductor patterns are interconnected in the layers in the stacking direction, thereby forming a coil spirally wound and overlapped in the stacking direction in a magnetic body. Respective ends of the coil are connected to electrodes provided on an outer surface of the stack.

To reduce the footprint of a multilayer inductor in, for example, a power supply circuit, external electrodes connected to the ends of the coil formed in the stack are provided on the bottom surface of the stack in the conventional technologies.

Examples of related-art are described in Japanese Laid-open Patent Publication No. 2014-022426 and in Japanese Patent No. 5621946.

FIGS. 1, 2, and 3 are diagrams illustrating a problem to be solved. FIG. 1 illustrates an example of a structure of a multilayer inductor 100 according to the related conventional technology. As described above, the multilayer inductor 100 includes magnetic layers and conductor pattern layers that are deposited to form a stack 113, and the conductor patterns are interconnected in the layers in the stacking direction (in the Z direction). The conductor patterns, which are interconnected in the layers, form a coil 103 that is spirally wound and overlapped in the Z direction in a magnetic body 101 of the multilayer inductor 100. The multilayer inductor 100 has a bottom-electrode arrangement and is provided with electrodes 109 and 111 on the bottom surface of the stack 113. First and second ends E1 and E2 of the coil are connected to the electrodes 109 and 111, respectively, via connecting conductors 105 and 107. The connecting conductor 105 passes through the stack 113 in the Z direction from the first end E1 of the coil 103 to the electrode 109. In the same manner, the connecting conductor 107 passes through the stack 113 in the Z direction from the second end E2 of the coil 103 to the electrode 111. Such a connecting conductor that passes through the stack from one end of the coil to the corresponding electrode may be referred to as a “through-hole conductor”.

When electric current I flows in the multilayer inductor 100 in the direction indicated by arrows in FIG. 1, the electric current I produces “main loops” that are a desired magnetic flux generated around the coil 103, while at the same time, produces “minor loops” that are a magnetic flux generated around the connecting conductors 105 and 107 (through-hole conductors). The minor loops are generated, for example, around the connecting conductor 105 as illustrated in FIG. 2, which illustrates a horizontal cross section C1 in FIG. 1 seen from above. The minor loops are generated, for example, around the connecting conductors 105 and 107 as illustrated in FIG. 3, which illustrates a horizontal cross section C2 in FIG. 1 seen from above.

The minor loops partially magnetically saturate the magnetic body near the connecting conductors 105 and 107. Such minor loops may cause additional loss in the multilayer inductor, in particular, additional core loss.

### SUMMARY

According to an aspect of an embodiment, a multilayer inductor includes a stack including a coil spirally wound and overlapped in a stacking direction in a magnetic body, an electrode provided on a bottom surface of the stack, a connecting conductor that passes through the stack toward the bottom surface from one end of the coil to the electrode to connect the end of the coil with the electrode, and a nonmagnetic part that surrounds the connecting conductor.

According to another aspect of an embodiment, a method for manufacturing a multilayer inductor includes screen printing at least one of a magnetic pattern, a first conductor pattern having an open-loop shape, and a second conductor pattern that forms a connecting conductor to fabricate a printed pattern layer, depositing the patterns by repeatedly performing the screen printing to form a stack, and providing an electrode on a bottom surface of the stack, wherein the screen printing includes screen printing a nonmagnetic pattern that surrounds the second conductor pattern, and the depositing includes interconnecting the first conductor patterns in layers to form a coil that is spirally wound and overlapped in a stacking direction in a magnetic body, connecting the second conductor patterns to form the connecting conductor that passes through the stack toward the bottom surface from one end of the coil to the electrode to connect the end of the coil with the electrode, and connecting the nonmagnetic patterns to form a nonmagnetic part that surrounds the connecting conductor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a problem to be solved;

FIG. 2 is another diagram illustrating the problem to be solved;

FIG. 3 is still another diagram illustrating the problem to be solved;

FIG. 4 is a diagram illustrating an example of a structure of a multilayer inductor according to one embodiment;

FIG. 5 is an exploded perspective view of the multilayer inductor according to one embodiment;

FIG. 6 is a diagram illustrating an example of a printed pattern according to one embodiment;

FIG. 7 is a diagram illustrating an example of another printed pattern according to one embodiment;

FIG. 8 is a diagram illustrating an example of still another printed pattern according to one embodiment; and

FIG. 9 is a diagram illustrating an example of yet another printed pattern according to one embodiment.

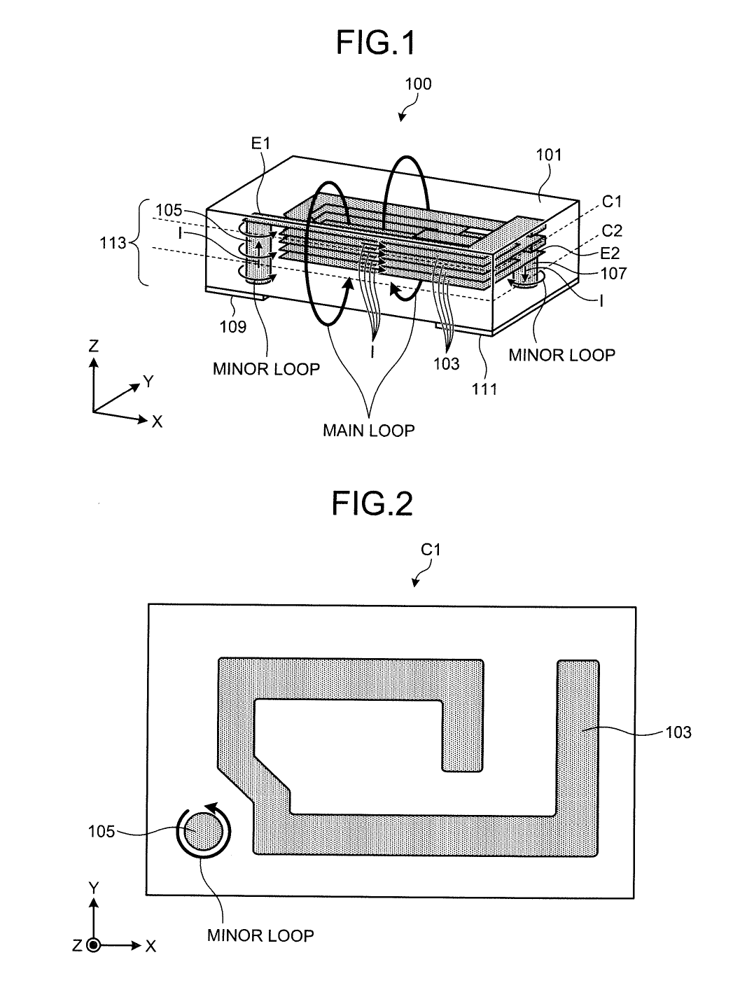

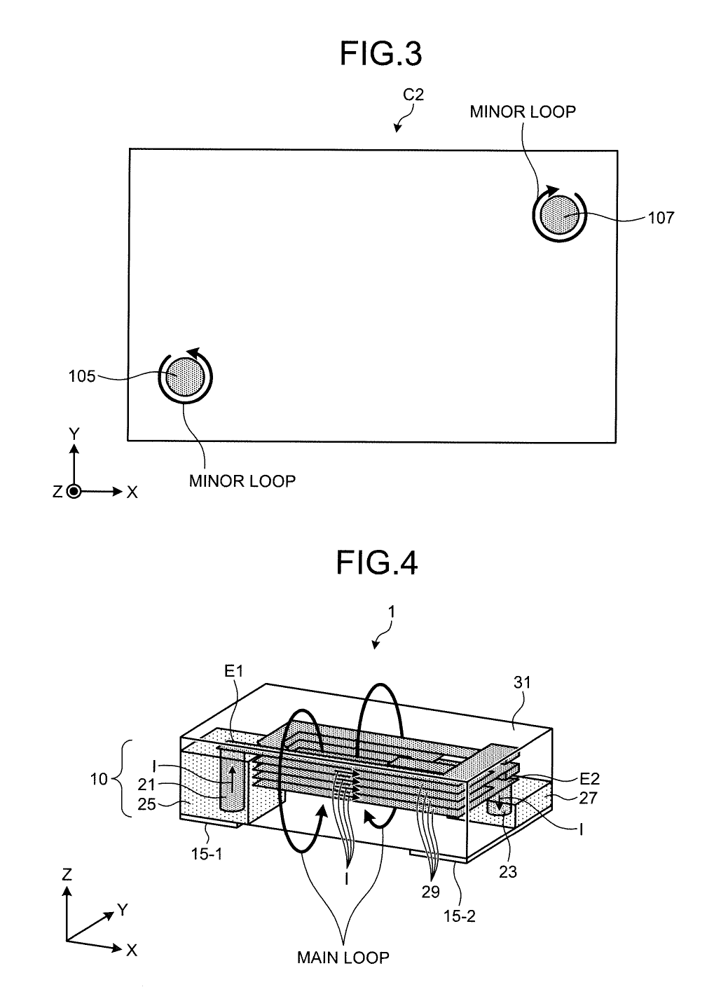

### DESCRIPTION OF EMBODIMENT

Preferred embodiments of the present invention will be explained with reference to accompanying drawings. The embodiments are presented for illustrative purposes only, and not intended to limit the scope of the multilayer inductor and the method for manufacturing the multilayer inductor according to the present disclosure. In the embodiments below, like reference signs refer to like components.

Structure of Multilayer Inductor

FIG. 4 is a diagram illustrating an example of a structure of a multilayer inductor according to one embodiment. This multilayer inductor 1 illustrated in FIG. 4 includes a magnetic body 31 and a coil 29 formed in the magnetic body 31 and spirally wound and overlapped in the Z direction (in the stacking direction). The multilayer inductor 1 has a bottom-electrode arrangement and is provided with electrodes 15-1 and 15-2 on the bottom surface of a stack 10 formed by depositing conductor patterns and nonmagnetic patterns. First and second ends E1 and E2 of the coil are connected to the electrodes 15-1 and 15-2, respectively, via connecting conductors (through-hole conductors) 21 and 23. The connecting conductor 21 passes through the stack 10 toward the bottom surface thereof from the first end E1 of the coil 29 to the electrode 15-1. In the same manner, the connecting conductor 23 passes through the stack 10 toward the bottom surface thereof from the second end E2 of the coil 29 to the electrode 15-2.

In other words, the multilayer inductor 1 includes the stack 10 and the electrodes 15-1 and 15-2 provided on the bottom surface of the stack 10. The stack 10 includes the magnetic body 31, the coil 29 formed in the magnetic body 31, and the connecting conductors 21 and 23. The magnetic body 31 is made of, for example, magnetic ferrite. The coil 29, the connecting conductors 21 and 23, and the electrodes 15-1 and 15-2 are made of, for example, silver.

The stack 10 includes nonmagnetic parts 25 and 27. The nonmagnetic parts 25 and 27 are made of, for example, nonmagnetic ferrite. In the stack 10, the connecting conductor 21 is surrounded by the nonmagnetic part 25 and the connecting conductor 23 is surrounded by the nonmagnetic part 27.

When electric current I flows in the multilayer inductor 1 in the direction indicated by arrows in FIG. 4, the electric current I produces main loops around the coil 29.

The nonmagnetic parts 25 and 27, which surround, respectively, the connecting conductors 21 and 23, block the minor loops around the connecting conductors 21 and 23. In other words, surrounding the connecting conductors 21 and 23 with the nonmagnetic parts 25 and 27 can prevent the minor loops from occurring. Preventing the minor loops can prevent the magnetic body 31 near the connecting conductors 21 and 23 from being partially and magnetically saturated. In this regard, surrounding the connecting conductors 21 and 23 with the nonmagnetic parts 25 and 27 can reduce the loss in the multilayer inductor 1.

The connecting conductors 21 and 23 have, for example, a cylindrical shape, and are disposed outward from the coil 29 at peripheral portions of the stack 10 (for example, located diagonally to each other near opposite corners of the stack 10). The nonmagnetic parts 25 and 27 that surround, respectively, the connecting conductors 21 and 23 have a substantially rectangular prism shape. The bottom surfaces of the nonmagnetic parts 25 and 27 constitute a part of the bottom surface of the stack 10.

Two of the four side surfaces of each of the nonmagnetic parts 25 and 27 constitute a part of the side surfaces of the stack 10. This configuration eliminates the magnetic body 31 from between the connecting conductors 21 and 23 and the side surfaces of the stack 10, and can prevent minor loops from occurring between the connecting conductors 21 and 23 and the side surfaces of the stack 10 without fail.

The nonmagnetic part 25 is in contact with the coil 29 in the stack 10. This configuration eliminates the magnetic body 31 from between the connecting conductor 21 and the coil 29, and can prevent minor loops from occurring between the connecting conductor 21 and the coil 29 without fail.

Two of the four side surfaces of each of the nonmagnetic parts 25 and 27 constitute a part of the side surfaces of the stack 10, and the nonmagnetic part 25 is in contact with the coil 29 in the stack 10. This configuration can prevent minor loops from occurring in the stack 10 without fail.

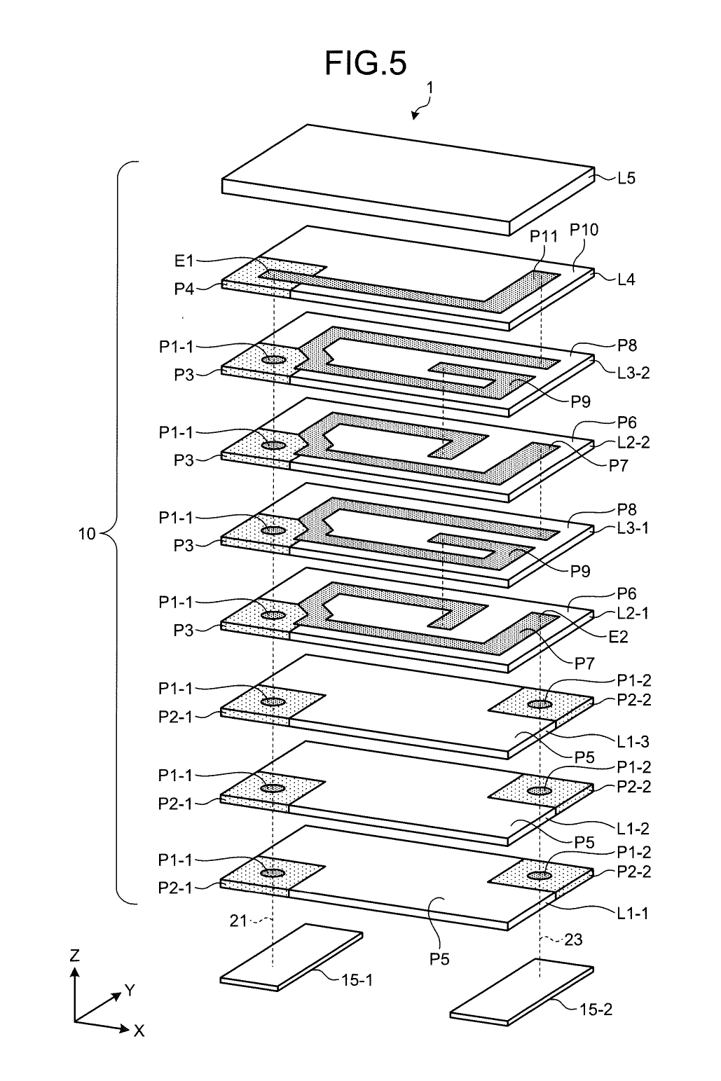

FIG. 5 is an exploded perspective view of the multilayer inductor according to one embodiment. As illustrated in FIG. 5, the stack 10 in the multilayer inductor 1 is configured by a plurality of layers from a layer L1-1 that forms the lowermost layer of the stack 10 to a layer L5 that forms the uppermost layer of the stack 10. In other words, the stack 10 has a multilayer structure of layers from the layer L1-1 to the layer L5 that are deposited in this order. The bottom surface of the layer L1-1, that is, the bottom surface of the stack 10 is provided with the electrodes 15-1 and 15-2. The layers L1-1 to L4 have the same thickness, whereas the layer L5 is thicker than the layers L1-1 to L4.

The layers L1-1, L1-2, and L1-3 have the same configuration including a magnetic portion P5, conductor portions P1-1 and P1-2, and nonmagnetic portions P2-1 and P2-2. The magnetic portion P5, the conductor portions P1-1 and P1-2, and the nonmagnetic portions P2-1 and P2-2 have the same thickness. In the following description, the layers L1-1, L1-2, and L1-3 are collectively referred to as a layer L1 unless otherwise specified. The conductor portions P1-1 and P1-2 are disposed at peripheral portions of the layer L1 (for example, located diagonally to each other near opposite corners of the layer L1), and the nonmagnetic portions P2-1 and P2-2 surround the conductor portions P1-1 and P1-2, respectively. When, for example, the conductor portions P1-1 and P1-2 are disposed diagonally to each other near opposite corners of the layer L1, two of the four sides of each of the square nonmagnetic portions P2-1 and P2-2 constitute a part of the four sides of the rectangular layer L1.

The layers L2-1 and L2-2 have the same configuration including a magnetic portion P6, conductor portions P1-1 and P7, and a nonmagnetic portion P3. The magnetic portion P6, the conductor portion P1-1, and the nonmagnetic portion P3 have the same thickness. The conductor portion P7 is thinner than the magnetic portion P6. In the following description, the layers L2-1 and L2-2 are collectively referred to as a layer L2 unless otherwise specified. The conductor portion P1-1 of the layer L2 is disposed at the same location as the conductor portion P1-1 of the layer L1. The nonmagnetic portion P3 is disposed at the same location as the nonmagnetic portion P2-1 of the layer L1. The conductor portion P7 has an open-loop shape and is formed in the magnetic portion P6. When the layer L2 is seen in the thickness direction (the Z direction), the top surface of the conductor portion P7 is flush with the top surface of the nonmagnetic portion P3. The nonmagnetic portion P3 is formed in contact with the conductor portion P7.

The layers L3-1 and L3-2 have the same configuration including a magnetic portion P8, conductor portions P1-1 and P9, and a nonmagnetic portion P3. The magnetic portion P8, the conductor portion P1-1, and the nonmagnetic portion P3 have the same thickness. The conductor portion P9 is thinner than the magnetic portion P8. In the following description, the layers L3-1 and L3-2 are collectively referred to as a layer L3 unless otherwise specified. The conductor portion P1-1 of the layer L3 is disposed at the same location as the conductor portions P1-1 of the layers L1 and L2. The nonmagnetic portion P3 is disposed at the same location as the nonmagnetic portion P2-1 of the layer L1 and the nonmagnetic portion P3 of the layer L2. The conductor portion P9 has an open-loop shape and is formed in the magnetic portion P8. When the layer L3 is seen in the thickness direction (the Z direction), the top surface of the conductor portion P9 is flush with the top surface of the nonmagnetic portion P3. The nonmagnetic portion P3 is formed in contact with the conductor portion P9.

The layer L4 includes a magnetic portion P10, a conductor portion P11, and a nonmagnetic portion P4. In the same manner as in the nonmagnetic portion P3, the nonmagnetic portion P4 has the conductor portion P1-1 at the center thereof, and the conductor portion P1-1 is connected to one end of the conductor portion P11. The magnetic portion P10, the conductor portion P1-1, and the nonmagnetic portion P4 have the same thickness. The conductor portion P11 is thinner than the magnetic portion P10. The nonmagnetic portion P4 is disposed at the same location as the nonmagnetic portion P2-1 of the layer L1, the nonmagnetic portion P3 of the layer L2, and the nonmagnetic portion P3 of the layer L3. The conductor portion P11 has an L shape and is formed in the magnetic portion P10. When the layer L4 is seen in the thickness direction (the Z direction), the top surface of the conductor portion P11 is flush with the top surface of the nonmagnetic portion P4. The nonmagnetic portion P4 is formed in contact with the conductor portion P11.

The layer L5 is entirely made of a magnetic substance.

The layers L2-1, L3-1, L2-2, L3-2, and L4 are deposited in this order and the conductor portions P7, P9, P11 of these layers are interconnected in the layers, thereby forming the coil 29 in the stack 10. The coil 29 is spirally wound and overlapped in the stacking direction (in the Z direction) in the magnetic body 31. In other words, one end of the conductor portion P11 of the layer L4 serves as the first end E1 of the coil 29, and the other end of the conductor portion P11 of the layer L4 is connected to one end of the conductor portion P9 of the layer L3-2 via a conductive via. The other end of the conductor P9 of the layer L3-2 is connected to one end of the conductor portion P7 of the layer L2-2 via a conductive via. The other end of the conductor P7 of the layer L2-2 is connected to one end of the conductor portion P9 of the layer L3-1 via a conductive via. The other end of the conductor P9 of the layer L3-1 is connected to one end of the conductor portion P7 of the layer L2-1 via a conductive via. The other end of the conductor portion P7 of the layer L2-1 serves as the second end E2 of the coil 29 and is connected to the conductor portion P1-2 of the layer L1-3 via a conductive via.

As the layers L1-1 to L4 are deposited, the conductor portions P1-1 are deposited to form the connecting conductor 21, and the nonmagnetic portions P2-1, P3, and P4 are deposited to form the nonmagnetic part 25 that surrounds the connecting conductor 21. The first end E1 of the coil 29 is connected to the connecting conductor 21.

As the layers L1-1 to L1-3 are deposited, the conductor portions P1-2 are deposited to form the connecting conductor 23, and the nonmagnetic portions P2-2 are deposited to form the nonmagnetic part 27 that surrounds the connecting conductor 23. The second end E2 of the coil 29 is connected to the connecting conductor 23.

On the bottom surface of the stack 10 (the bottom surface of the layer L1-1), the connecting conductor 21 (the connecting portion P1-1) is connected to the electrode 15-1, and the connecting conductor 23 (the conductor portion P1-2) is connected to the electrode 15-2.

Method for Manufacturing Multilayer Inductor

The magnetic portions P5, P6, P8, and P10, the conductor portions P1-1, P1-2, P7, P9, and P11, and the nonmagnetic portions P2-1, P2-2, P3, and P4 are fabricated by screen printing as a magnetic pattern, a conductor pattern, and a nonmagnetic pattern, respectively, as described below. The layers L1-1 to L4 correspond to “printed pattern layers” fabricated by screen printing of the magnetic pattern, the conductor pattern, or the nonmagnetic pattern. For example, the magnetic pattern is fabricated by screen printing using paste magnetic ferrite, the conductor pattern is fabricated by screen printing using paste silver, and the nonmagnetic pattern is fabricated by screen printing using paste nonmagnetic ferrite.

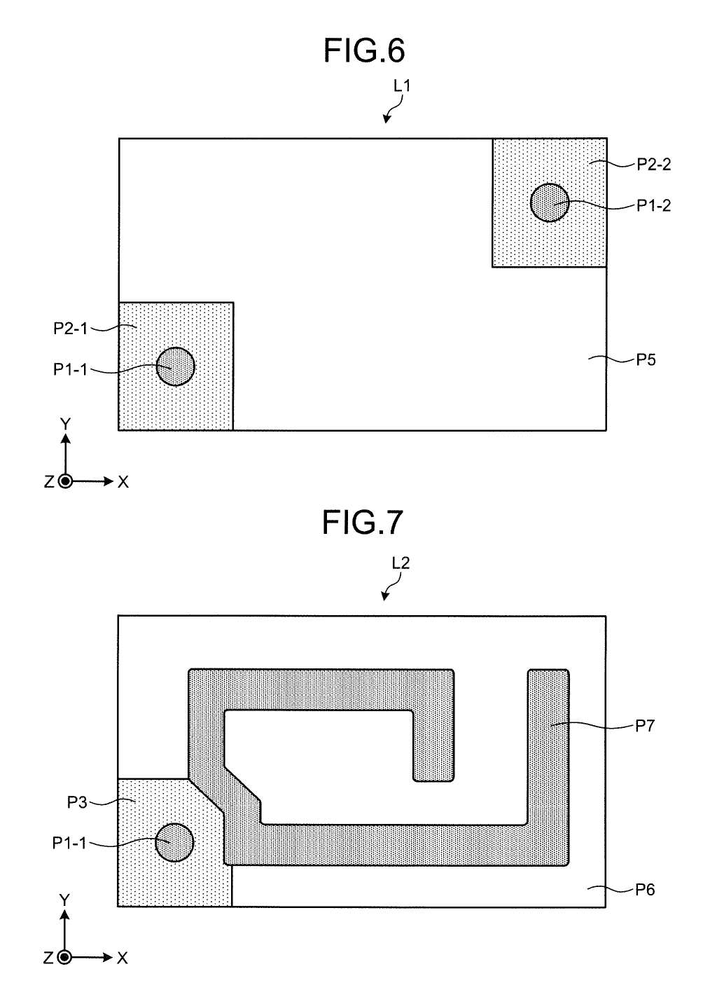

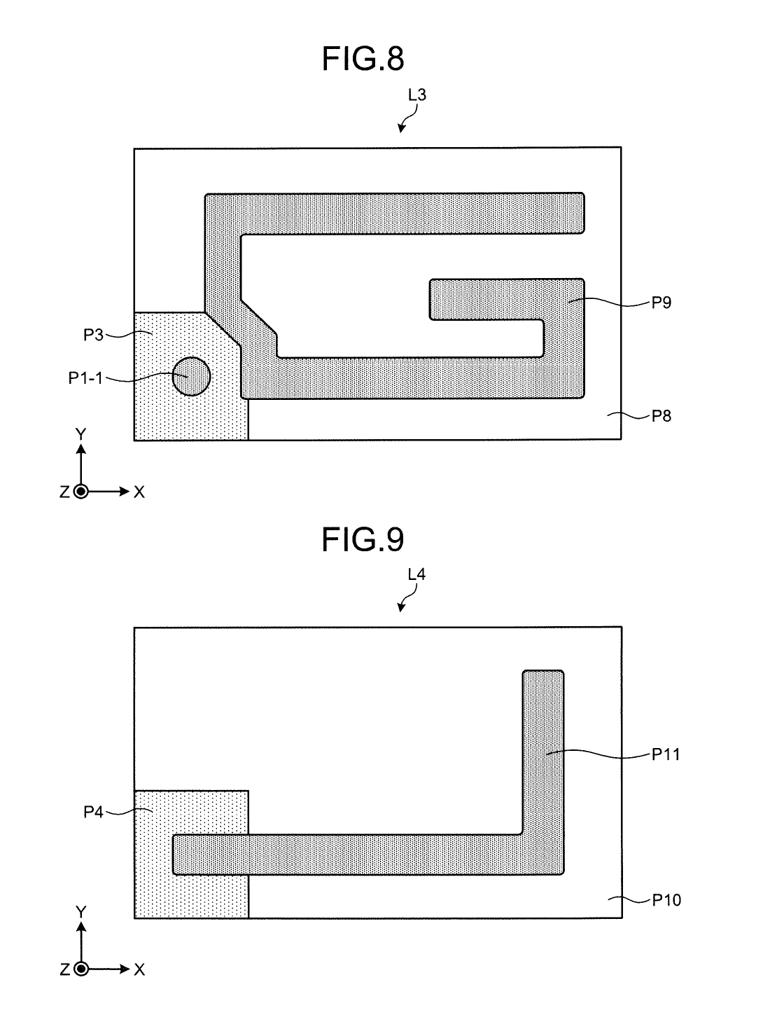

FIGS. 6 to 9 are diagrams illustrating examples of printed patterns according to one embodiment. FIG. 6 illustrates a printed pattern of the layer L1, FIG. 7 illustrates a printed pattern of the layer L2, FIG. 8 illustrates a printed pattern of the layer L3, and FIG. 9 illustrates a printed pattern of the layer L4.

As illustrated in FIG. 6, the layer L1 is fabricated by screen printing of the magnetic pattern P5, the conductor patterns P1-1 and P1-2, and the nonmagnetic patterns P2-1 and P2-2.

As illustrated in FIG. 7, the layer L2 is fabricated by screen printing of the magnetic pattern P6, the conductor patterns P1-1 and P7, and the nonmagnetic pattern P3.

As illustrated in FIG. 8, the layer L3 is fabricated by screen printing of the magnetic pattern P8, the conductor patterns P1-1 and P9, and the nonmagnetic pattern P3.

As illustrated in FIG. 9, the layer L4 is fabricated by screen printing of the magnetic pattern P10, the conductor pattern P11, the nonmagnetic pattern P4, and the conductor pattern P1-1 at the center of the nonmagnetic pattern P4 (the conductor pattern P1-1 is disposed under the conductor pattern P11 and thus not illustrated).

The electrodes 15-1 and 15-2 are provided on the bottom surface of the stack 10, which includes the patterns and the layer L5 deposited by screen printing as described above, and the stack 10 is fired at a certain low temperature (for example, a temperature at which silver will not melt) and the multilayer inductor 1 is completed.

In other words, the magnetic patterns, the conductor patterns, and the nonmagnetic patterns described above are repeatedly screen printed and deposited, thereby forming the stack 10.

In this deposition process, the conductor patterns P7, P9, and P11 are interconnected in the layers to form the coil 29. The conductor patterns P1-1 are connected to each other to form the connecting conductor 21 and the conductor patterns P1-2 are connected to each other to form the connecting conductor 23. In the deposition process, the nonmagnetic patterns P2-1, P3, and P4 are connected to each other to form the nonmagnetic part 25, and the nonmagnetic patterns P2-2 are connected to each other to form the nonmagnetic part 27.

In the screen printing of the layer L1, as illustrated in FIG. 6, the conductor patterns P1-1 and P1-2 are screen printed on peripheral portions of the layer L1, and the nonmagnetic patterns P2-1 and P2-2 are screen printed to surround the conductor patterns P1-1 and P1-2, respectively, with a part of the periphery of the nonmagnetic patterns P2-1 and P2-2 constituting a part of the periphery of the layer L1.

In the screen printing of the layer L2, as illustrated in FIG. 7, the conductor pattern P1-1 is screen printed on a peripheral portion of the layer L2 outward from the conductor pattern P7, and the nonmagnetic pattern P3 is screen printed to surround the conductor pattern P1-1 with a part of the periphery of the nonmagnetic pattern P3 constituting a part of the periphery of the layer L2. Furthermore, in the screen printing of the layer L2, the nonmagnetic pattern P3 is screen printed with a part of the periphery of the nonmagnetic pattern P3 being in contact with the conductor pattern P7.

In the screen printing of the layer L3, as illustrated in FIG. 8, the conductor pattern P1-1 is screen printed on a peripheral portion of the layer L3 outward from the conductor pattern P9, and the nonmagnetic pattern P3 is screen printed to surround the conductor pattern P1-1 with a part of the periphery of the nonmagnetic pattern P3 constituting a part of the periphery of the layer L3. Furthermore, in the screen printing of the layer L3, the nonmagnetic pattern P3 is screen printed with a part of the periphery of the nonmagnetic pattern P3 being in contact with the conductor pattern P9.

Printing the magnetic patterns, the conductor patterns, and the nonmagnetic patterns in the manner as described above can efficiently manufacture a multilayer inductor having through-hole conductors surrounded by a nonmagnetic substance.

According to the embodiments of the present disclosure, loss in a multilayer inductor can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A multilayer inductor comprising:
a stack including a coil spirally wound and overlapped in a stacking direction in a magnetic body;
an electrode provided on a bottom surface of the stack;
a connecting conductor that passes through the stack toward the bottom surface from one end of the coil to the electrode to connect the end of the coil with the electrode; and
a nonmagnetic part that surrounds the connecting conductor.

2. The multilayer inductor according to claim 1, wherein
the connecting conductor is disposed outward from the coil, and
a part of a side surface of the nonmagnetic part that surrounds the connecting conductor constitutes a part of a side surface of the stack.

3. The multilayer inductor according to claim 2, wherein the nonmagnetic part that surrounds the connecting conductor is in contact with the coil in the stack.

4. A method for manufacturing a multilayer inductor, the method comprising:
screen printing at least one of a magnetic pattern, a first conductor pattern having an open-loop shape, and a second conductor pattern that forms a connecting conductor to fabricate a printed pattern layer;
depositing the patterns by repeatedly performing the screen printing to form a stack; and
providing an electrode on a bottom surface of the stack, wherein
the screen printing includes screen printing a nonmagnetic pattern that surrounds the second conductor pattern, and
the depositing includes
interconnecting the first conductor patterns in layers to form a coil that is spirally wound and overlapped in a stacking direction in a magnetic body,
connecting the second conductor patterns to form the connecting conductor that passes through the stack toward the bottom surface from one end of the coil to the electrode to connect the end of the coil with the electrode, and
connecting the nonmagnetic patterns to form a nonmagnetic part that surrounds the connecting conductor.

5. The method for manufacturing the multilayer inductor according to claim 4, wherein the screen printing includes
screen printing the second conductor pattern at a location outward from the first conductor pattern, and
screen printing the nonmagnetic pattern that surrounds the second conductor pattern such that a part of a periphery of the nonmagnetic pattern constitutes a part of a periphery of the printed pattern layer.

6. The method for manufacturing a multilayer inductor according to claim 5, wherein the screen printing includes screen printing the nonmagnetic pattern that surrounds the second conductor pattern such that a part of the periphery of the nonmagnetic pattern is in contact with the first conductor pattern.
